(19) United States
(12) Patent Application Publication
(10) Pub. No.: US 2025/0240393 A1
(43) Pub. Date: Jul. 24, 2025

(54) CALIBRATION METHOD, SYSTEM, AND NON-TRANSITORY COMPUTER-READABLE STORAGE MEDIUM STORING PROGRAM

(71) Applicant: SEIKO EPSON CORPORATION, Tokyo (JP)

(72) Inventors: Kota TAKEUCHI, AZUMINO-SHI (JP); Kosuke SAKU, MATSUMOTO-SHI (JP)

(21) Appl. No.: 19/036,449

(22) Filed: Jan. 24, 2025

(30) Foreign Application Priority Data
Jan. 24, 2024 (JP) 2024-008537

(51) Int. Cl. H04N 9/31

(52) U.S. Cl. CPC H04N 9/3194; H04N 9/3185

(57) ABSTRACT

Provided is a calibration method that includes projecting a first image including a phase shift pattern from a projector onto a projection surface, acquiring a first imaged image that includes the first image and is imaged by a camera, generating a mask image based on the first imaged image, projecting a second image that includes a structured light pattern and is masked by the mask image from the projector onto the projection surface, acquiring a second imaged image that includes the second image and is imaged by the camera, and associating coordinates in an imaging coordinate system of the camera with coordinates in a display coordinate system of the projector based on the second imaged image.

The present application is based on, and claims priority from JP Application Serial Number 2024-008537, filed Jan. 24, 2024, the disclosure of which is hereby incorporated by reference herein in its entirety.

### BACKGROUND

### 1. Technical Field

The present disclosure relates to a calibration method, a system, and a non-transitory computer-readable storage medium storing a program.

### 2. Related Art

JP-A-2009-48015 discloses a projector that projects a display image on a wall surface of a room. Both side wall surfaces, a ceiling surface, and a floor surface are adjacent to the wall surface.

In order to suitably project an image onto a projection surface by a projector, it is necessary to specify an association relationship between coordinates in a display coordinate system of the projector and coordinates on the projection surface. However, in the related art, when another wall surface or the like is present in the vicinity of an outer edge of the projection surface, there is a problem that it is difficult to measure the association relationship with high accuracy due to reflected light or the like from the other wall surface to the projection surface.

### SUMMARY

A calibration method according to an aspect of the present disclosure includes: projecting a first image including a phase shift pattern from a projector onto a projection surface; acquiring a first imaged image that includes the first image and is imaged by a camera; generating a mask image based on the first imaged image; projecting a second image that includes a structured light pattern and is masked by the mask image from the projector onto the projection surface; acquiring a second imaged image that includes the second image and is imaged by the camera; and associating coordinates in an imaging coordinate system of the camera with coordinates in a display coordinate system of the projector based on the second imaged image.

A system according to an aspect of the present disclosure includes: a camera; and a projector communicably connected to the camera. The projector is configured to project a first image including a phase shift pattern onto a projection surface, acquire a first imaged image obtained by imaging the first image by the camera, generate a mask image based on the first imaged image, project a second image that includes a structured light pattern and is masked by the mask image onto the projection surface, acquire a second imaged image obtained by imaging the second image by the camera, and associate coordinates in an imaging coordinate system of the camera with coordinates in a display coordinate system of the projector based on the second imaged image.

A non-transitory computer-readable storage medium storing a program according to an aspect of the present disclosure causes a computer to: project a first image including a phase shift pattern from a projector onto a projection surface; acquire a first imaged image by imaging the first image by a camera; generate a mask image based on the first imaged image; project a second image that includes a structured light pattern and is masked by the mask image from the projector onto the projection surface; acquire a second imaged image by imaging the second image by the camera; and associate coordinates in an imaging coordinate system of the camera with coordinates in a display coordinate system of the projector based on the second imaged image.

### BRIEF DESCRIPTION OF THE DRAWINGS

FIG. 1 is a view illustrating an overview of a system according to a first embodiment.

FIG. 2 is a block diagram illustrating a projector used in the system according to the first embodiment.

FIG. 3 is a flowchart illustrating a flow of a calibration method according to the first embodiment.

FIG. 4 is a view illustrating first images.

FIG. 5 is a view illustrating an imaged image.

FIG. 6 is a view illustrating amplitude intensity images based on a first imaged image.

FIG. 7 is a view illustrating determination of a mask shape.

FIG. 8 is a view illustrating a mask image in an imaging coordinate system.

FIG. 9 is a view illustrating a mask image in a display coordinate system.

FIG. 10 is a view illustrating a second image.

FIG. 11 is a block diagram illustrating a projector used in a system according to a second embodiment.

FIG. 12 is a flowchart illustrating a flow of a calibration method according to the second embodiment.

FIG. 13 is a view illustrating an image for region designation.

### DESCRIPTION OF EMBODIMENTS

Preferred embodiments according to the present disclosure are described below with reference to the accompanying drawings. In the drawings, dimensions and scales of units are different from actual ones as appropriate and some portions are schematically illustrated to facilitate understanding. Further, the scope of the present disclosure is not limited to these embodiments unless particularly described to limit the present disclosure in the following description.

### 1. FIRST EMBODIMENT

### 1-1. System Overview

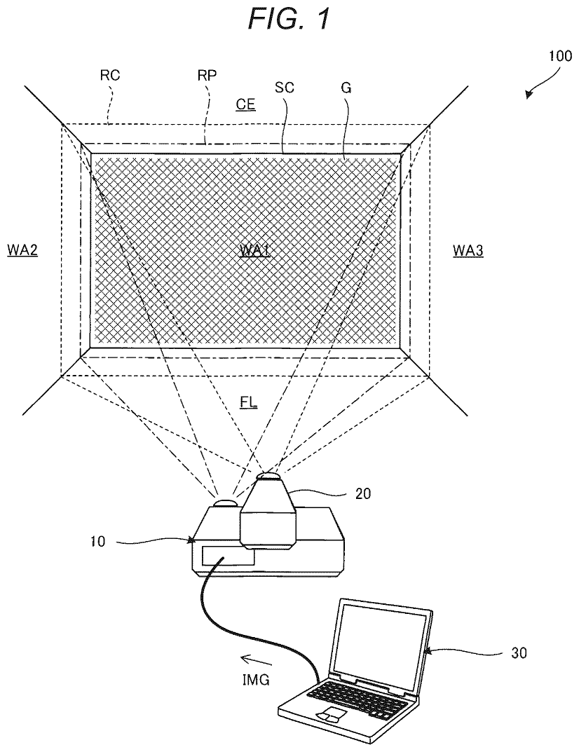

FIG. 1 is a view illustrating an overview of a system 100 according to the first embodiment. The system 100 is a projection system that projects a projection image G onto a projection surface SC. In FIG. 1, a direction in which a ceiling surface CE, a wall surface WA1, and a floor surface FL are arranged in this order when viewed from a direction perpendicular to the paper surface is referred to as an up-down direction, a side close to the ceiling surface CE when viewed from the wall surface WA1 is referred to as an upper side in the drawing, and a side close to the floor surface FL when viewed from the wall surface WA1 is referred to as a lower side in the drawing. In FIG. 1, a direction in which a wall surface WA2, the wall surface WA1, and a wall surface WA3 are arranged in this order when viewed from the direction perpendicular to the paper surface is referred to as a left-right direction, a side close to the wall surface WA2 when viewed from the wall surface WA1 is referred to as a left side, and a side close to the wall surface WA3 when viewed from the wall surface WA1 is referred to as a right side in the drawing.

The projection surface SC is the wall surface WA1. The wall surface WA2 is adjacent to the left side of the wall surface WA1 in the drawing. On the other hand, the wall surface WA3 is adjacent to the right side of the wall surface WA1 in the drawing. The ceiling surface CE is adjacent to the upper side of the wall surface WA1 in the drawing. On the other hand, the floor surface FL is adjacent to the lower side of the wall surface WA1 in the drawing. In this manner, the wall surface WA1 is a surface surrounded by the wall surfaces WA2 and WA3, the ceiling surface CE, and the floor surface FL.

The projection surface SC is not limited to the wall surface WA1, and may be, for example, a surface of an object such as a screen. The projection surface SC is not limited to a flat surface, and may be, for example, a surface curved in a concave shape or a convex shape.

As illustrated in FIG. 1, the system 100 includes a projector 10, a camera 20, and a terminal device 30.

The projector 10 is a display device that projects, onto the projection surface SC, a projection image G indicated by video data IMG output from the terminal device 30. In an example illustrated in FIG. 1, the projection image G is projected in a quadrangular region extending over substantially the entire of the projection surface SC. The projector 10 can project the projection image G in a region RP including the projection surface SC. In FIG. 1, the projection image G is shaded. A projection position and a shape of the projection image G onto the projection surface SC are not limited to the example illustrated in FIG. 1, and are optional.

The projector 10 according to the present embodiment has a function of controlling an operation of the camera 20 and a function of adjusting a shape of the projection image G using an imaging result of the camera 20.

The camera 20 is a digital camera including an imaging device such as a charge coupled device (CCD) or a complementary metal oxide semiconductor (CMOS).

The camera 20 images a region RC. The region RC is a region including the projection image G projected onto the projection surface SC. In the example illustrated in FIG. 1, the region RC includes the region RP. The camera 20 may be an element of the projector 10.

The terminal device 30 is a computer having a function of supplying the video data IMG to the projector 10. In the example illustrated in FIG. 1, the terminal device 30 is a laptop computer. Note that the terminal device 30 is not limited to the laptop computer and may be, for example, a desktop computer, a smartphone, or a tablet terminal, or may be a video player, a digital versatile disk (DVD) player, a Blu-ray Disc player, a hard disk recorder, a television tuner, a set-top box for a cable television (CATV), a video game machine, or the like.

### 1-2. Projector

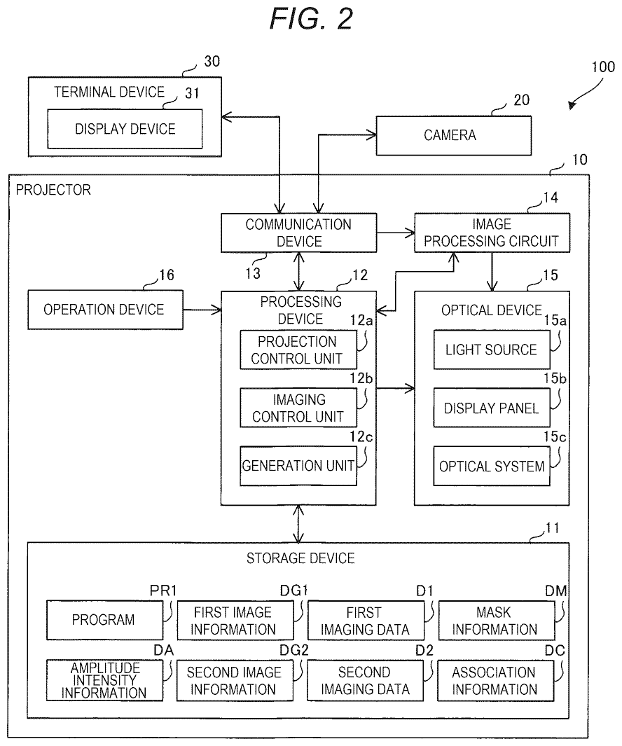

FIG. 2 is a block diagram illustrating the projector 10 used in the system 100 according to the first embodiment. FIG. 2 illustrates a connection state of the camera 20 and the terminal device 30 to the projector 10 in addition to the illustration of the projector 10. In an example illustrated in FIG. 2, the terminal device 30 includes a display device 31. The display device 31 is a display device including various display panels such as a liquid crystal display panel and an organic EL display panel.

As illustrated in FIG. 2, the projector 10 includes a storage device 11, a processing device 12, a communication device 13, an image processing circuit 14, an optical device 15, and an operation device 16. These devices are communicably connected to one another.

The storage device 11 is a storage device that stores programs to be executed by the processing device 12 and data to be processed by the processing device 12. The storage device 11 includes, for example, a hard disk drive or a semiconductor memory. A part or all of the storage device 11 may be provided in a storage device, a server, or the like outside the projector 10.

The storage device 11 stores a program PR1, first image information DG1, second image information DG2, first imaging data D1, second imaging data D2, mask information DM, amplitude intensity information DA, and association information DC.

The program PR1 is a program for executing a calibration method to be described in detail later.

The first image information DG1 is information indicating a first image G1 to be described later. The first image G1 includes a phase shift pattern PT to be described later, and is projected onto the projection surface SC by the projector 10.

The first imaging data D1 is information indicating a first imaged image GG1 which is to be described later and obtained by the camera 20 imaging the first image G1 projected on the projection surface SC.

The amplitude intensity information DA is information indicating an amplitude intensity image GG2 which is to be described later and generated based on the first imaging data D1. The amplitude intensity image GG2 is an image that emphasizes an edge of the first imaged image GG1 indicated by the first imaging data D1.

The mask information DM is information indicating a mask image M to be described later.

The second image information DG2 is information indicating a second image G2 to be described later. The second image G2 includes a structured light pattern, is masked by the mask image M which is to be described later and indicated by the mask information DM, and is projected onto the projection surface SC by the projector 10.

The second imaging data D2 is information indicating a second imaged image obtained by the camera 20 imaging the second image G2 projected on the projection surface SC.

The association information DC is information indicating an association relationship between coordinates in a display coordinate system of the projector 10 and coordinates in an imaging coordinate system of the camera 20. The display coordinate system of the projector 10 is a coordinate system in which a pixel of a display panel 15b to be described later is set as a coordinate value. The imaging coordinate system of the camera 20 is a coordinate system in which a pixel of an imaging element of the camera 20 is set as a coordinate value.

The processing device 12 is a processing device having a function of controlling units of the projector 10 and a function of processing various kinds of data. For example, the processing device 12 includes a processor such as a central processing unit (CPU). Note that the processing device 12 may be implemented by a single processor or may be implemented by a plurality of processors. A part or all of functions of the processing device 12 may be implemented by hardware such as a digital signal processor (DSP), an application specific integrated circuit (ASIC), a programmable logic device (PLD), or a field programmable gate array (FPGA). The processing device 12 may be integrated with at least a part of the image processing circuit 14.

The communication device 13 is a communication device that can communicate with various devices, and acquires the video data IMG from the terminal device 30 and communicates with the camera 20. For example, the communication device 13 is a wired communication device such as a wired local area network (LAN), a universal serial bus (USB), and a high definition multimedia interface (HDMI), or a wireless communication device such as a low power wide area (LPWA), wireless LAN including Wi-Fi, and a Bluetooth device. The “HDMI”, “Wi-Fi”, and “Bluetooth” are registered trademark.

The image processing circuit 14 is a circuit that executes necessary processing on the video data IMG from the communication device 13 and inputs the processed data to the optical device 15. The image processing circuit 14 includes, for example, a frame memory (not illustrated), loads the video data IMG into the frame memory, appropriately executes various kinds of processing such as resolution conversion processing, resizing processing, and distortion correction processing, and inputs the processed data to the optical device 15. Here, the above-described association information DC is appropriately used in the various kinds of processing. The image processing circuit 14 may execute processing such as on screen display (OSD) processing of generating image information for menu display, operation guidance, or the like and combining the image information with the video data IMG as needed.

The optical device 15 is a device that projects image light onto the projection surface SC. The optical device 15 includes a light source 15a, the display panel 15b, and an optical system 15c.

The light source 15a includes a light source such as a halogen lamp, a xenon lamp, an ultra-high pressure mercury lamp, a light emitting diode (LED), or a laser light source, and emits red light, green light, and blue light. The display panel 15b is a light modulator including three light modulation elements provided corresponding to red, green, and blue. The light modulation element includes, for example, a transmissive liquid crystal panel, a reflective liquid crystal panel, or a digital mirror device (DMD), and modulates light of a corresponding color to generate image light of the color. The image light of each color generated by the display panel 15b are combined by a color combination optical system to be full color image light. The optical system 15c is a projection optical system including a projection lens that forms an image of the full color image light from the display panel 15b and projects the image onto the projection surface SC.

The operation device 16 is a device that receives an operation from a user. For example, the operation device 16 includes an operation panel and a remote control receiver (not illustrated). The operation panel is provided in an exterior housing of the projector 10 and outputs a signal based on an operation from the user. The remote control receiver receives an infrared signal from a remote controller (not illustrated), decodes the infrared signal, and outputs a signal based on an operation of the remote controller. The operation device 16 is provided as needed, or may be omitted.

In the projector 10 described above, the processing device 12 functions as a projection control unit 12a, an imaging control unit 12b, and a generation unit 12c by executing the program PR1 stored in the storage device 11. Therefore, the processing device 12 includes the projection control unit 12a, the imaging control unit 12b, and the generation unit 12c.

The projection control unit 12a controls operations of the image processing circuit 14 and the optical device 15. More specifically, the projection control unit 12a projects the projection image G onto the projection surface SC according to operation control of the optical device 15. More specifically, the projection control unit 12a projects the first image G1 to be described later onto the projection surface SC based on the first image information DG1, and projects the second image G2 to be described later onto the projection surface SC based on the second image information DG2.

The imaging control unit 12b controls an operation of the camera 20. More specifically, the imaging control unit 12b acquires the first imaging data D1 by causing the camera 20 to image the first image G1 which is to be described later and projected onto the projection surface SC, or acquires the second imaging data D2 by causing the camera 20 to image the second image G2 which is to be described later and projected onto the projection surface SC. Then, the imaging control unit 12b stores the acquired first imaging data D1 and second imaging data D2 in the storage device 11.

The generation unit 12c generates temporary association information DC, or generates the amplitude intensity information DA and the mask information DM based on the first imaging data D1. The generation unit 12c generates new association information DC based on the second imaging data D2.

### 1-3. Calibration Method

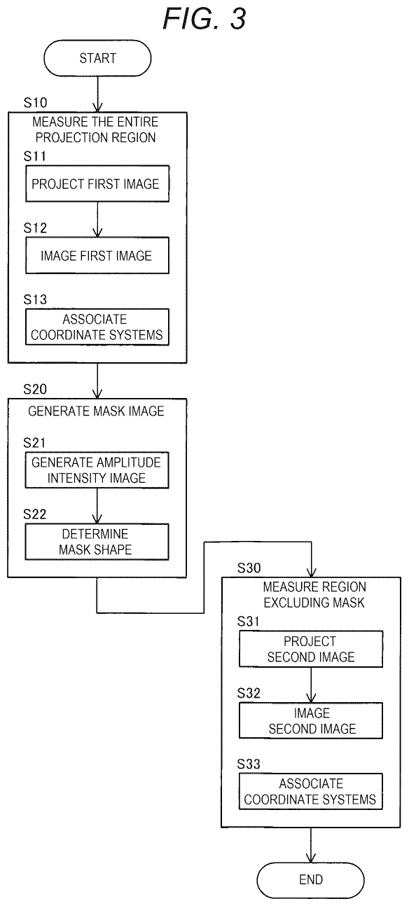

FIG. 3 is a flowchart illustrating a flow of the calibration method according to the first embodiment. The calibration method is executed by executing the program PR1 by the processing device 12, which is an example of a “computer”, using the above-described system 100. Here, as described above, the system 100 includes the camera 20 and the projector 10 communicably connected to the camera 20.

The calibration method includes step S10, step S20, and step S30. Here, the projector 10 executes step S10 to step S30. Further, the program PR1 causes the processing device 12 to execute steps S10 to S30.

In step S10, measurement is performed by a phase shift method over the entire region RP. Step S10 includes steps S11, S12, and S13. In step S11, the projector 10 projects the first image G1 to be described later as the projection image G onto the projection surface SC. The projection is performed by the projection control unit 12a controlling operations of the image processing circuit 14 and the optical device 15 based on the first image information DG1.

In step S12, the camera 20 images the first image G1 to be described later to acquire the first imaged image GG1 to be described later. The acquisition is performed by the imaging control unit 12b controlling an operation of the camera 20. The first imaging data D1 is generated by the acquisition, and the generated first imaging data D1 is stored in the storage device 11.

In step S13, coordinates in the display coordinate system of the projector 10 are associated with coordinates in the imaging coordinate system of the camera 20 over the entire region RP described above based on the first imaged image GG1. The association is performed by the generation unit 12c based on the first imaging data D1 using a known measurement method. The temporary association information DC is generated by the association, and the generated association information DC is stored in the storage device 11.

In step S20, the mask image M is generated based on the first imaged image GG1. The generation is performed by the generation unit 12c based on the first imaging data D1 using a result of extracting a contour of the projection surface SC. The mask information DM is generated by the generation, and the generated mask information DM is stored in the storage device 11.

Step S20 in the present embodiment includes step S21 and step S22. In step S21, an amplitude intensity image indicated by the amplitude intensity information DA is generated based on the first imaged image GG1. In step S22, a shape of the mask image M is determined based on the amplitude intensity image indicated by the amplitude intensity information DA.

In step S30, measurement is performed by a phase shift method over a region excluding a region indicated by the mask information DM in the above-described region RP. Step S30 includes step S31, step S32, and step S33. In step S31, the projector 10 projects the second image G2 to be described later as the projection image G onto the projection surface SC. The projection is performed by the projection control unit 12a controlling operations of the image processing circuit 14 and the optical device 15 based on the second image information DG2.

In step S32, the camera 20 images the second image G2 to be described later to acquire a second imaged image. The acquisition is performed by the imaging control unit 12b controlling an operation of the camera 20. The second imaging data D2 is generated by the acquisition, and the generated second imaging data D2 is stored in the storage device 11.

In step S33, the coordinates in the imaging coordinate system of the camera 20 are associated with the coordinates in the display coordinate system of the projector 10 based on the second imaged image indicated by the second imaging data D2. The association is performed by the generation unit 12c based on the second imaging data D2 using a known measurement method. The new association information DC is generated by the association, and the generated association information DC is stored in the storage device 11.

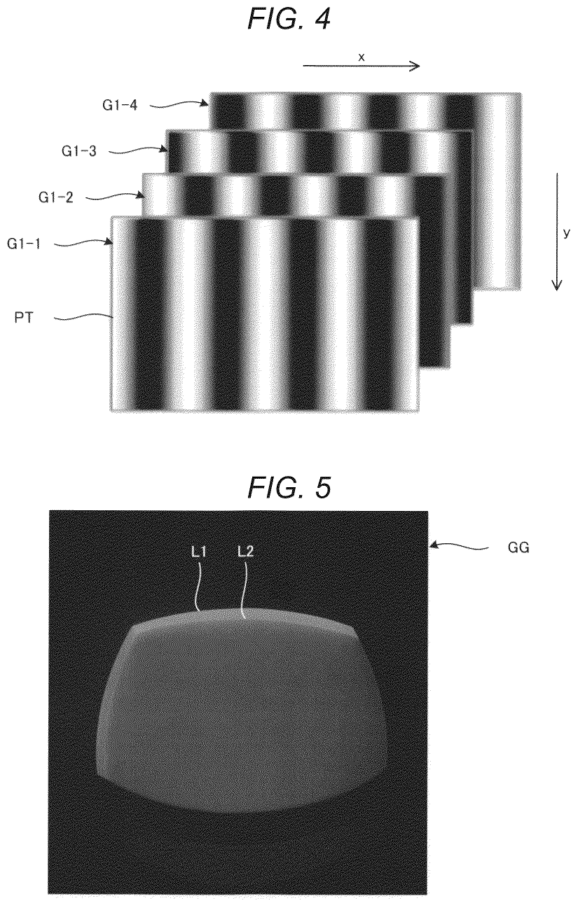

FIG. 4 is a view illustrating first images G1-1 to G1-4. FIG. 4 illustrates the first images G1-1 to G1-4 in the display coordinate system of the projector 10. In FIG. 4, an x direction which is a horizontal direction and a y direction which is a vertical direction in the display coordinate system of the projector 10 are illustrated together.

Each of the first images G1-1 to G1-4 is an image including a phase shift pattern PT. Hereinafter, the first images G1-1 to G1-4 may be referred to as the first image G1 without distinction.

The phase shift pattern PT is a stripe pattern in which a luminance value changes along a sine wave in the x direction. The first images G1-1 to G1-4 are the same except that phases of the phase shift patterns PT are different from one another. The phases of the phase shift patterns PT included in the first images G1-1 to G1-4 are shifted by π/2 from one another.

In an example illustrated in FIG. 4, the phase shift pattern PT has four stripes. The number of stripes included in the phase shift pattern PT is not limited to the example illustrated in FIG. 4, and may be two or more.

In step S11, the projector 10 sequentially projects the first images G1-1 to G1-4 onto the projection surface SC. In step S12, the camera 20 images the first image G1 projected onto the projection surface SC for each projection. Accordingly, in step S12, the camera 20 images the first images G1-1 to G1-4 projected onto the projection surface SC. Accordingly, the first imaging data D1 is obtained.

In step S13, an association relationship between the coordinate values in the display coordinate system of the projector 10 and the coordinate values in the imaging coordinate system of the camera 20 over the entire region RP is temporarily obtained by the phase shift method. Accordingly, the temporary association information DC is generated. Such an association relationship is obtained using the following Formulas (1) and (2).

$$i = \frac{T}{2 π} x = \frac{T}{2 π} {tan}^{- 1} ( \frac{{I}_{4} ( u , v ) - {I}_{2} ( u , v )}{{I}_{1} ( u , v ) - {I}_{3} ( u , v )} ) \qquad ( 1 )$$

In Formula (1), i is a stripe number of the phase shift pattern PT and is an x coordinate in the display coordinate system of the projector 10, T is the number of pixels in one cycle of the phase shift pattern PT, I₁ (u, v) is a luminance value I(u, v) at coordinates (u, v) of an image obtained by imaging the first image G1-1, I₂ (u, v) is a luminance value I(u, v) at coordinates (u, v) of an image obtained by imaging the first image G1-2, I₃ (u, v) is a luminance value I(u, v) at coordinates (u, v) of an image obtained by imaging the first image G1-3, and I₄ (u, v) is a luminance value I(u, v) at coordinates (u, v) of an image obtained by imaging the first image G1-4.

$$\begin{matrix}I ( u , v ) = A cos ( x ) + B \\ A = \frac{1}{2} \sqrt{{( {I}_{1} ( u , v ) - {I}_{3} ( u , v ) )}^{2} + {( {I}_{4} ( u , v ) - {I}_{2} ( u , v ) )}^{2}} \\ B = \frac{{I}_{1} ( u , v ) + {I}_{2} ( u , v ) + {I}_{3} ( u , v ) + {I}_{4} ( u , v )}{4}\end{matrix} \qquad ( 2 )$$

In Formula (2), A is a luminance value depending on reflection, diffusion, absorption, camera sensitivity, and the like of light in an imaging region, and B is luminance depending on a background color, camera tone, central luminance of a panel, and the like.

As described above, even when absolute values of the luminance values I(u, v) at the same coordinate x of the four imaged images obtained by imaging the first images G1-1 to G1-4 are changed by a surface state or color of an object to be measured at the coordinate x, a relative value is changed by a phase difference of a stripe pattern. Accordingly, a phase value of the stripe pattern at the coordinate x can be obtained while reducing an influence of environmental light, the surface state of the object to be measured, or the like.

Here, the phase value is not a continuous value in an imaged image, but is obtained in a range of −π to +π for each stripe of a stripe pattern. Such a phase value is phase-coupled (phase-connected) by a known method so as to be a continuous value in an imaged image.

FIG. 5 is a view illustrating an imaged image GG. FIG. 5 illustrates the imaged image GG obtained by imaging a white image by the camera 20 when the white image is projected over the entire region RP. In FIG. 5, the imaged image GG in the imaging coordinate system when the camera 20 is a camera using a fish eye lens is illustrated.

As illustrated in FIG. 5, lines L1 and L2 indicating edges appear in the imaged image GG. The line L1 is a line along an outer edge of the region RP. The line L2 is a line along an outer edge of the projection surface SC, that is, an outer edge of the wall surface WA1.

A region between the line L1 and the line L2 is a region outside the projection surface SC, specifically, a region of the wall surface WA2, the wall surface WA3, the ceiling surface CE, or the floor surface FL. When projection is performed in the region between the line L1 and the line L2, reflected light in the region reaches an outer peripheral portion of the projection surface SC or the like. Therefore, in step S11, when the phase shift pattern PT is projected over the entire region RP described above, an error occurs in the measurement of the projection surface SC by the phase shift method.

Therefore, after step S10, the system 100 generates the mask image M having a shape that is not projected onto the region between the line L1 and the line L2 in step S20, and measures the projection surface SC using the mask image M by the phase shift method in step S30. Accordingly, the above-described error can be reduced.

Here, in step S30, it is necessary to detect the line L2 as the outer edge of the projection surface SC and determine the shape of the mask image M using a detection result of the line L2. However, in the imaged image GG, since the line L1 appears in addition to the line L2, and a contrast difference between the inside and the outside of the line L2 is small, it is difficult to detect the outer edge of the projection surface SC with high accuracy.

Therefore, the system 100 generates the amplitude intensity image GG2 based on the first imaged image GG1 in step S21, and determines the mask shape based on the amplitude intensity image GG2 in step S22.

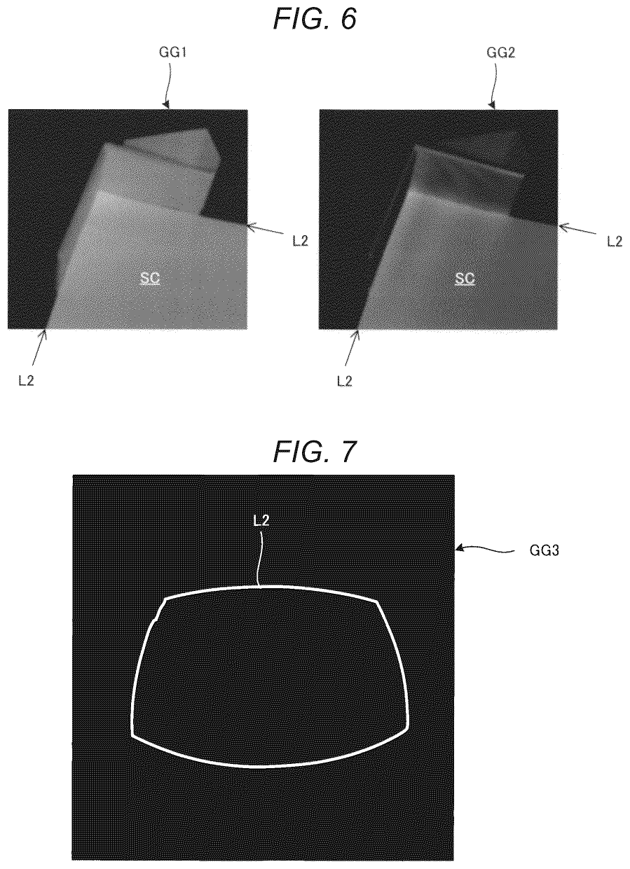

FIG. 6 is a view illustrating the amplitude intensity image GG2 based on the first imaged image GG1. In FIG. 6, a part of the first imaged image GG1 is illustrated on the left side of the drawing, and the amplitude intensity image GG2 is illustrated on the right side of the drawing.

In the amplitude intensity image GG2 illustrated on the right side in FIG. 6, since the contrast difference between the inside and the outside of the line L2 is large as compared with the first imaged image GG1 illustrated on the left side in FIG. 6, the outer edge of the projection surface SC can be detected with high accuracy. The amplitude intensity image GG2 is an image in which a luminance value of each pixel is A in the above Formula 2.

FIG. 7 is a view illustrating determination of the mask shape. In step S22, the line L2 in the amplitude intensity image GG2 is detected to generate a mask shape image GG3 indicating the mask shape as illustrated in FIG. 7.

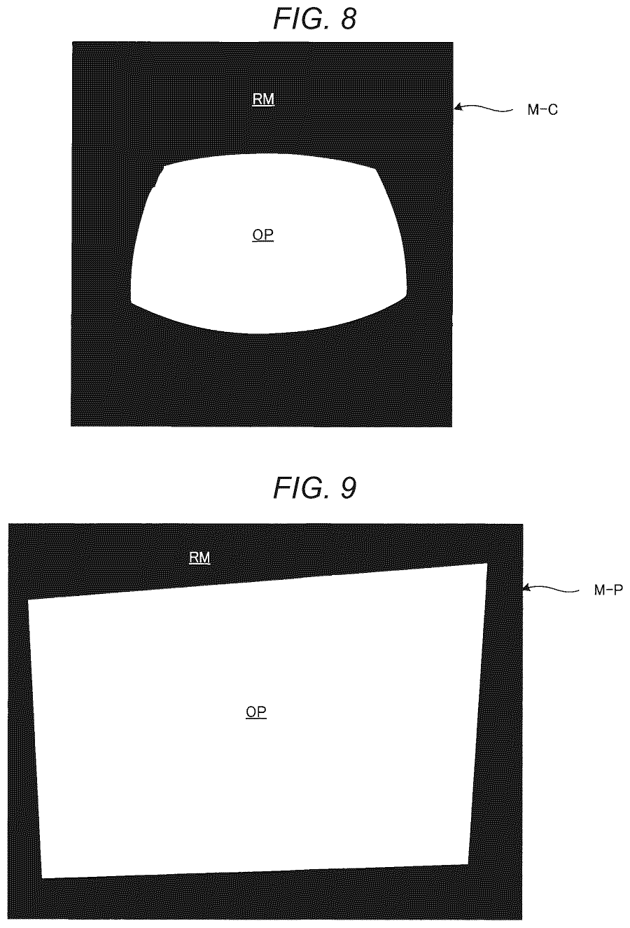

FIG. 8 is a view illustrating the mask image M in the imaging coordinate system. In step S20, a mask image M-C is generated by executing image processing so that the inside of the line L2 in the mask shape image GG3 is set as a transmissive region OP and the outside of the line L2 is set as a non-transmissive region RM. The mask image M-C is a mask image in the imaging coordinate system.

FIG. 9 is a view illustrating the mask image M in the display coordinate system. In step S20, a mask image M-P is generated by converting the mask image M-C into the display coordinate system of the projector 10 using the temporary association information DC obtained in step S10. Hereinafter, the mask images M-C and M-P may be referred to as the mask image M without distinction.

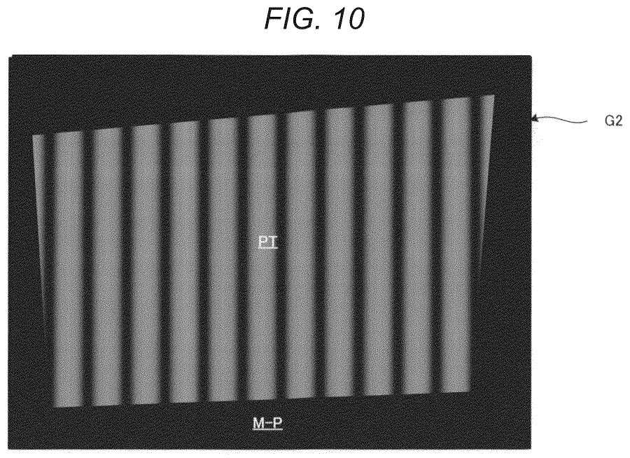

FIG. 10 is a view illustrating the second image G2. After the second image G2 is generated using the mask image M-P in step S30, the second image G2 is projected onto the projection surface SC in step S31.

In the present embodiment, as illustrated in FIG. 10, the second image G2 includes the phase shift pattern PT and is masked by the mask image M-P. Here, the phase shift pattern PT is displayed in the transmissive region OP and masked in the non-transmissive region RM. The phase shift pattern PT of the second image G2 is an example of a “structured light pattern”. Although one second image G2 is illustrated in FIG. 10, similar to the first images G1-1 to G1-4, four second images G2 in which phases of the phase shift patterns PT are shifted by π/2 from one another are used. In step S32, the camera 20 images the four second images G2 for each projection. Accordingly, the second imaging data D2 is obtained.

The structured light pattern used in the second image G2 is not limited to the phase shift pattern PT, and for example, may be other structured light patterns such as a binary code pattern, a dot pattern, a rectangular pattern, a polygonal pattern, a checker pattern, a gray code pattern, and a random dot pattern.

In step S33, the association relationship between coordinate values in the display coordinate system of the projector 10 and coordinate values in the imaging coordinate system of the camera 20 in a region excluding a region masked by the mask image M in the region RP. Accordingly, new association information DC is generated. In the present embodiment, such an association relationship is obtained by the phase shift method as described above.

In the calibration method described above, since the first image G1 includes the phase shift pattern PT, a region to be masked of the projection surface SC can be determined with high accuracy based on the first imaged image GG1. As a result, the mask image M that masks a desired region of the projection surface SC can be generated. In addition, by using such a mask image M as the second image G2, the projection surface SC can be measured with high accuracy based on the second imaged image indicated by the second imaging data D2. As a result, the coordinates in the imaging coordinate system of the camera 20 and the coordinates in the display coordinate system of the projector 10 can be associated with each other with high accuracy. By using this association, it is possible to specify the association relationship between the coordinates in the display coordinate system of the projector 10 and coordinates on the projection surface SC with high accuracy.

In the present embodiment, as described above, the phase shift pattern PT can be shared by the first image G1 and the second image G2 by using the phase shift pattern PT with the second image G2 serving as the structured light pattern.

As described above, step S20 of generating the mask image M includes step S21 and step S22. Here, in step S21, the amplitude intensity image indicated by the amplitude intensity information DA is generated based on the first imaged image GG1. In step S22, a shape of the mask image M is determined based on the amplitude intensity image indicated by the amplitude intensity information DA. According to step S21 and step S22, accuracy of edge detection in the first imaged image GG1 can be increased.

### 2. SECOND EMBODIMENT

Hereinafter, the second embodiment of the present disclosure will be described. In the embodiment described below, components having the same effects and functions as those in the first embodiment are denoted by the same reference numerals used in the first embodiment, and detailed description will be omitted as appropriate.

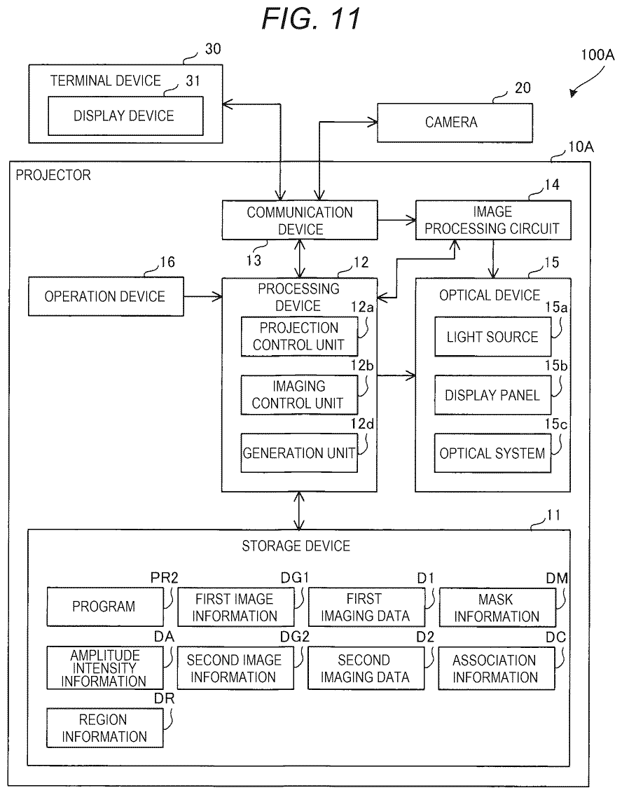

FIG. 11 is a block diagram illustrating a projector 10A used in a system 100A according to the second embodiment. The system 100A has a similar configuration to the system 100 in the first embodiment except that the projector 10A is provided instead of the projector 10 in the first embodiment. The projector 10A has a similar configuration to the projector 10 in the first embodiment except that a program PR2 is used instead of the program PR1 in the first embodiment.

The program PR2 is similar to the program PR1 in the first embodiment except that the processing device 12 functions as a generation unit 12d instead of the generation unit 12c in the first embodiment.

The generation unit 12d is similar to the generation unit 12c in the first embodiment except that the generation unit 12d causes the display device 31 to display an image GU for region designation and determines a mask shape using a result of the region designation in addition to the amplitude intensity image GG2.

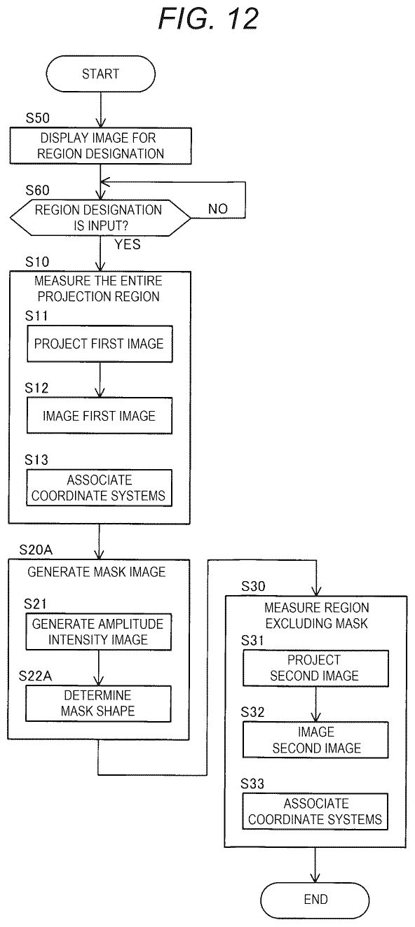

FIG. 12 is a flowchart illustrating a flow of a calibration method according to the second embodiment. The calibration method is similar to the calibration method in the first embodiment except that step S20A is provided instead of step S20 in the first embodiment and steps S50 and S60 are added.

In the calibration method according to the present embodiment, first, in step S50, the image GU to be described later for region designation is displayed on the display device 31. The display is performed by the generation unit 12d controlling an operation of the display device 31. Thereafter, in step S60, it is determined whether region designation is input. The determination is performed by the generation unit 12d monitoring an input result to the terminal device 30. Step S60 is repeatedly executed until the region designation is input (step S60: NO).

When the region designation is input (step S60: YES), step S10 is executed as in the first embodiment. Thereafter, step S20A is executed.

Step S20A is similar to step S20 in the first embodiment except that step S22A is executed instead of step S22 in the first embodiment. Step S22A is similar to step S22 in the first embodiment except that the mask shape is determined using a result of the region designation in addition to the amplitude intensity image GG2. For example, steps S50 and S60 may be executed before step S22A, and are not limited to the example illustrated in the drawing. For example, steps S50 and S60 may be executed between step S10 and step S20A, or may be performed in step S10 or in step S20A.

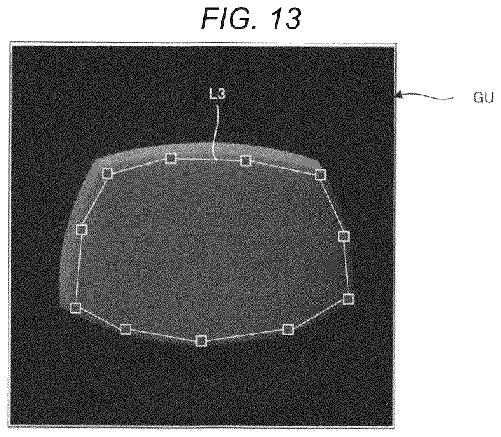

FIG. 13 is a view illustrating the image GU for region designation. In step S50, the image GU is displayed on the display device 31. The image GU is a graphical user interface (GUI) image for receiving region designation.

The image GU can receive adjustment of a shape and a size of a region in an imaging region. In the example illustrated in FIG. 13, a plurality of dots are arranged along a contour L3 of a region to be designated. For example, the region is adjusted by selecting any one dot from the plurality of dots and then moving the selected dot using a cursor. A display for adjusting the region is not limited to the example illustrated in FIG. 13, and is optional.

Although not illustrated, the designation of the region is performed by, for example, operating a determination button displayed on the display device 31.

According to the second embodiment described above, it is also possible to achieve highly accurate calibration between coordinate systems of the camera 20 and the projector 10. As described above, the calibration method in the present embodiment includes step S50 and step S60. In step S50, an image for designating a region on the projection surface SC is displayed on the display device 31. In step S60, an input for designating a region is received from a user. Step S22A of determining a shape of the mask image M includes determining the shape of the mask image M based on the amplitude intensity image GG2 and the region. Accordingly, accuracy of edge detection in the first imaged image GG1 can be increased.

### 3. MODIFICATIONS

The embodiments described above can be modified in various manners. Specific aspects of modifications applicable to the embodiments described above are exemplified below. Two or more aspects optionally selected from the following exemplifications can be combined as appropriate within a range in which no mutual conflict exists.

### 3-1. Modification 1

Although an aspect in which the processing device 12 of the projector 10 executes the programs PR1 and PR2 is exemplified in the embodiments described above, the present disclosure is not limited to this aspect, and for example, a processing device of a computer communicably connected to the projector 10 and the camera 20 may execute the programs PR1 and PR2.

### 3-2. Modification 2

Although an aspect in which the association information DC is used for adjustment of the projection image G is exemplified in the embodiments described above, the present disclosure is not limited to this aspect, and for example, the association information DC may be used for displaying a pattern of a lattice shape or the like having uniformity on the projection surface SC, or may be used for, after reflecting a three-dimensional shape model of the projection surface SC viewed from the camera 20 on a three-dimensional image editing software or the like, drawing a picture on the model, causing a PC monitor or the like to display how the picture is seen from the projector 10, and causing the projector 10 to project the picture.

### 4. APPENDIXES

The present disclosure will be summarized below in the form of appendixes.

(Appendix 1) According to a first aspect which is a preferred example of a calibration method of the present disclosure, the calibration method including:
projecting a first image including a phase shift pattern from a projector onto a projection surface;
acquiring a first imaged image that includes the first image and is imaged by a camera;
generating a mask image based on the first imaged image;
projecting a second image that includes a structured light pattern and is masked by the mask image from the projector onto the projection surface;
acquiring a second imaged image that includes the second image and is imaged by the camera; and
associating coordinates in an imaging coordinate system of the camera with coordinates in a display coordinate system of the projector based on the second imaged image.

In the above aspect, since the first image includes the phase shift pattern, a region to be masked on the projection surface can be determined with high accuracy based on the first imaged image. Accordingly, a mask image that masks a desired region of the projection surface can be generated with high accuracy. By using such a mask image as the second image, it is possible to suitably prevent reflection of unnecessary light from an object around the projection surface onto the projection surface. Therefore, based on the second imaged image, the coordinates in the imaging coordinate system of the camera can be associated with coordinates in the display coordinate system of the projector with high accuracy with reference to coordinates on the projection surface. By using this association, it is possible to specify the association relationship between the coordinates in the display coordinate system of the projector and the coordinates on the projection surface with high accuracy.

(Appendix 2) In a second aspect which is a preferred example of the first aspect, the structured light pattern is a phase shift pattern. In the above aspect, the phase shift pattern can be shared by the first image and the second image.

(Appendix 3) In a third aspect which is a preferred example of the first aspect or the second aspect, generating the mask image includes generating an amplitude intensity image based on the first imaged image, and determining a shape of the mask image based on the amplitude intensity image. In the above aspect, accuracy of edge detection in the first imaged image can be increased.

(Appendix 4) In a fourth aspect which is a preferred example of the third aspect, the calibration method further includes: displaying an image for designating a region on the projection surface on a display device; and receiving an input for designating the region from a user, in which determining the shape of the mask image includes determining the shape of the mask image based on the amplitude intensity image and the region. In the above aspect, accuracy of edge detection in the first imaged image can be increased.

(Appendix 5) According to a fifth aspect which is a preferred example of a system of the present disclosure, the system includes: a camera; and a projector communicably connected to the camera, in which the projector is configured to project a first image including a phase shift pattern onto a projection surface, acquire a first imaged image obtained by imaging the first image by the camera, generate a mask image based on the first imaged image, project a second image that includes a structured light pattern and is masked by the mask image onto the projection surface, acquire a second imaged image obtained by imaging the second image by the camera, and associate coordinates in an imaging coordinate system of the camera with coordinates in a display coordinate system of the projector based on the second imaged image.

In the above aspect, since the first image includes the phase shift pattern, a region to be masked on the projection surface can be determined with high accuracy based on the first imaged image. Accordingly, a mask image that masks a desired region of the projection surface can be generated with high accuracy. By using such a mask image as the second image, it is possible to suitably prevent reflection of unnecessary light from an object around the projection surface onto the projection surface. Therefore, based on the second imaged image, the coordinates in the imaging coordinate system of the camera can be associated with coordinates in the display coordinate system of the projector with high accuracy with reference to coordinates on the projection surface. By using this association, it is possible to specify the association relationship between the coordinates in the display coordinate system of the projector and the coordinates on the projection surface with high accuracy.

(Appendix 6) According to a sixth aspect which is a preferred example of a non-transitory computer-readable storage medium storing a program of the present disclosure, the program causes a computer to: project a first image including a phase shift pattern from a projector onto a projection surface; acquire a first imaged image by imaging the first image by a camera; generate a mask image based on the first imaged image; project a second image that includes a structured light pattern and is masked by the mask image from the projector onto the projection surface; acquire a second imaged image by imaging the second image by the camera; and associate coordinates in an imaging coordinate system of the camera with coordinates in a display coordinate system of the projector based on the second imaged image.

In the above aspect, since the first image includes the phase shift pattern, a region to be masked on the projection surface can be determined with high accuracy based on the first imaged image. Accordingly, a mask image that masks a desired region of the projection surface can be generated with high accuracy. By using such a mask image as the second image, it is possible to suitably prevent reflection of unnecessary light from an object around the projection surface onto the projection surface. Therefore, based on the second imaged image, the coordinates in the imaging coordinate system of the camera can be associated with coordinates in the display coordinate system of the projector with high accuracy with reference to coordinates on the projection surface. By using this association, it is possible to specify the association relationship between the coordinates in the display coordinate system of the projector and the coordinates on the projection surface with high accuracy.

What is claimed is:

1. A calibration method comprising:
projecting a first image including a phase shift pattern from a projector onto a projection surface;
acquiring a first imaged image that includes the first image and is imaged by a camera;
generating a mask image based on the first imaged image;
projecting a second image that includes a structured light pattern and is masked by the mask image from the projector onto the projection surface;
acquiring a second imaged image that includes the second image and is imaged by the camera; and
associating coordinates in an imaging coordinate system of the camera with coordinates in a display coordinate system of the projector based on the second imaged image.

2. The calibration method according to claim 1, wherein
the structured light pattern is a phase shift pattern.

3. The calibration method according to claim 1, wherein
generating the mask image includes
generating an amplitude intensity image based on the first imaged image, and
determining a shape of the mask image based on the amplitude intensity image.

4. The calibration method according to claim 3, further comprising:
displaying an image for designating a region on the projection surface on a display device; and
receiving an input for designating the region from a user, wherein
determining the shape of the mask image includes determining the shape of the mask image based on the amplitude intensity image and the region.

5. A system comprising:
a camera; and
a projector communicably connected to the camera, wherein
the projector is configured to
project a first image including a phase shift pattern onto a projection surface,
acquire a first imaged image obtained by imaging the first image by the camera,
generate a mask image based on the first imaged image,
project a second image that includes a structured light pattern and is masked by the mask image onto the projection surface,
acquire a second imaged image obtained by imaging the second image by the camera, and
associate coordinates in an imaging coordinate system of the camera with coordinates in a display coordinate system of the projector based on the second imaged image.

6. A non-transitory computer-readable storage medium storing a program causing a computer to:
project a first image including a phase shift pattern from a projector onto a projection surface;
acquire a first imaged image by imaging the first image by a camera;
generate a mask image based on the first imaged image;
project a second image that includes a structured light pattern and is masked by the mask image from the projector onto the projection surface;
acquire a second imaged image by imaging the second image by the camera; and
associate coordinates in an imaging coordinate system of the camera with coordinates in a display coordinate system of the projector based on the second imaged image.
